(19) United States
(12) Patent Application Publication
(10) Pub. No.: US 2010/0312857 A1
(43) Pub. Date: Dec. 9, 2010

(54) System and method for enabling content aggregation by user proximity

(75) Inventor: Geoff Ehlers, Santa Rosa, CA (US)

Correspondence Address: PATENT DEPARTMENT;ROVI CORPORATION, 2830 DE LA CRUZ BOULEVARD, SANTA CLARA, CA, 95050, US

(73) Assignee: Macrovision Solutions Corporation

(21) Appl. No.: 12/455,691

(22) Filed: Jun. 5, 2009

(51) Int. Cl. G06F 15/16; G06F 3/00

(52) U.S. Cl. 709/219; 715/704

(57) ABSTRACT

A computer-implemented system and method for enabling content aggregation by user proximity are disclosed. The apparatus and method in an example embodiment includes: obtaining available content listing information identifying particular items of content available from a plurality of content sources; determining a physical location corresponding to each of the plurality of content sources; determining a physical proximity of the particular items of content to a user based on the physical location corresponding to each of the plurality of content sources and a location of the user; arranging the content listing information according to the physical proximity of the particular items of content to the user; and presenting a view to the user showing the arranged content listing information.

### BACKGROUND

1. Copyright Notice

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008-2009, Macrovision Solutions Corporation, All Rights Reserved.

2. Technical Field

This disclosure relates to networked systems. More particularly, the present disclosure relates to enabling content aggregation by user proximity.

3. Related Art

In conventional content aggregation and delivery systems, it can be difficult to manage content for playback on a particular client playback device when there are multiple playback devices and multiple instances (copies) of a particular desired item of content. Typically, a user is more likely to care about content that is physically closer (e.g., proximate) to the user than content that is farther away. However, conventional systems do not arrange listings of content in a manner that conveys a sense of physical proximity of the content to the user. Conventional systems also do not enable access to content in a manner that relates to the physical proximity of the content to the user.

Thus, a computer-implemented system and method for enabling content aggregation by user proximity is needed.

### BRIEF DESCRIPTION OF THE DRAWINGS

Embodiments are illustrated by way of example and not limitation in the figures of the accompanying drawings, in which:

FIG. 1 illustrates an example embodiment of a networked system in which various embodiments may operate.

FIG. 2 illustrates an example embodiment showing the functional components of the content manager.

FIG. 3 illustrates another example embodiment of a networked system in which various embodiments may operate.

FIG. 4 illustrates another example embodiment of a networked system showing various content sources at four different levels of physical proximity where a client system manages the content.

FIG. 5 illustrates another example embodiment of a networked system showing various content sources at four different levels of physical proximity where a content server manages the content.

FIG. 6 illustrates an example user interface of a particular embodiment.

FIG. 7 illustrates another example user interface of a particular embodiment.

FIG. 8 is a processing flow diagram illustrating a sequence of processing operations in an example embodiment.

FIG. 9 shows a diagrammatic representation of a machine in the form of a computer system within which a set of instructions, for causing the machine to perform any one or more of the methodologies discussed herein, may be executed, according to an example embodiment.

### DETAILED DESCRIPTION

A computer-implemented system and method for enabling content aggregation by user proximity are disclosed. In the following description, numerous specific details are set forth. However, it is understood that embodiments may be practiced without these specific details. In other instances, well-known processes, structures and techniques have not been shown in detail in order not to obscure the clarity of this description. Various embodiments are described below in connection with the figures provided herein.

U.S. Pat. No. 6,889,207 describes devices and methods for controlling content within a device environment through interaction among electronic devices of the environment. The device has a transmitter, receiver, memory storing interaction rules and content rules and a processor for implementing the interaction rules and content rules in association with the transmitter, receiver, and other devices of the environment. Methods involve obtaining content information of the media about to be played and comparing the content information to the content rules stored at a device. An instruction about playback of the media content is generated. Methods may also involve seeking rights information for media content and determining whether rights information exists for identified media content in response to the request. When rights information does exist for the identified media content, a message is sent that includes the rights information.

United States Patent Publication No. 2007/0049296 describes a system, method and device for transmitting content from a wireless communication network to a plurality of remote devices within a proximity area according to a proximity map. The method includes a server bundling content into a first bundle in which the first bundle includes content for delivery to the plurality of remote devices and transmitting the first bundle to a first remote device of the plurality of remote devices according to the proximity map. Additionally, disclosed is the first remote device transmitting to a second remote device a second bundle including content of the first bundle.

U.S. Pat. No. 6,006,264 describes a content-aware flow switch that intercepts a client content request in an IP network, and transparently directs the content request to a best-fit server. The best-fit server is chosen based on the type of content requested, the quality of service requirements implied by the content request, the degree of load on available servers, network congestion information, and the proximity of the client to available servers. The flow switch detects client-server flows based on the arrival of TCP SYNs and/or HTTP GETs from the client. The flow switch implicitly deduces the quality of service requirements of a flow based on the content of the flow. The flow switch also provides the functionality of multiple physical web servers on a single web server in a way that is transparent to the client, through the use of virtual web hosts and flow pipes.

### Overview of Various Embodiments

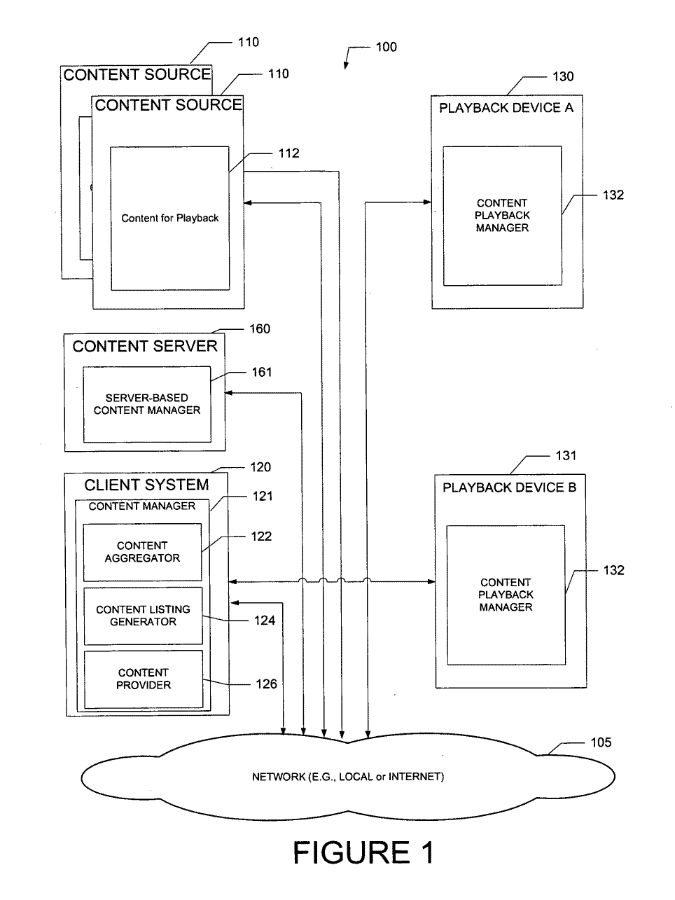

The content aggregation by proximity process and system of the various embodiments described herein enable content aggregation, listing, and consumption by user proximity. As described herein, a content server can be considered a network-accessible server, server farm, web site, or the like that can enable local or network access to items of content for client systems with playback devices via local or network interfaces (e.g., a local area network, such as a LAN; a wide-area network, such as the Internet). FIG. 1 illustrates an example embodiment of a networked system with which various embodiments may operate. As shown in FIG. 1, a content server 160 is in networked data communication, via a conventional network 105 such as the Internet, with one or more client systems 120, which are in networked data communication with some playback devices 130 or in direct data communication with other playback devices 131. In some embodiments, playback devices 130 can also be configured to communicate directly with content server 160 via network 105. Playback devices 131 can use local interfaces such as USB or local wireless interfaces such as Bluetooth, 802.11, or 802.3 for direct data communication with client system 120. Client systems 120 and/or playback devices 130 and/or 131 can be used by individuals who can log in to or otherwise gain access to the content server 160 via the network 105 and become subscribers or members of a content aggregation service enabled by the various embodiments described herein. In a particular embodiment shown in FIG. 1, a content playback manager 132 can be provided in or by playback devices 130 and/or 131. As described in more detail below, the content playback manager 132 can control the flow of a selected item of content into (and out of) a user playback device content buffer for playback to a user. In the example embodiment shown, client system 120 can include a content manager 121 having a content aggregator 122, a content listing generator 124, and a content provider 126. Content aggregator 122 includes processing logic to communicate with the content server 160 and/or one or more content feeds or content repositories (herein content sources) 110 to coordinate access to a user-selected item of content directly from the one or more content sources 110 by the user playback device 130 via network 105 or via the content server 160 and client system 120. Content listing generator 124 includes processing logic to communicate with the content server 160 and/or with one or more content sources 110 to obtain available content listing information identifying particular items of content 112 available through particular content sources 110. In a particular embodiment, this content listing information can also include location information that can be used by the client system 120 to determine a physical distance between a physical location of the source of the particular content item and the physical location of a user or the playback device of a requesting user. These content listings from various content sources 110 can be posted on content server 160 and/or client system 120 for viewing, searching, and selection by users of client system 120 and/or playback devices 130 and/or 131. The users of playback devices 130 and/or 131 can log in to accounts maintained on content server 160 or client system 120, search a listing of available content, and select a particular item of content for download or streaming to the user's playback device via local interfaces or network 105. Content provider 126 includes processing logic to communicate with the content server 160 and/or one or more content sources 110 and one or more playback devices 130 or 131 to facilitate the downloading or streaming of a particular selected item of content to a playback device of a requesting user. Content sources 110 can be feeds or repositories of digital content 112 that can be downloaded or streamed to a particular client system 120 or playback device 130 via network 105. Content 112 can be any of various forms of digital content including video or multimedia (e.g., MPEG), still images (e.g., JPEG or TIFF), audio (e.g., MP3), spoken audio, digital documents, executable code, and the like. Content sources 110 can represent websites, servers, peer-to-peer nodes, databases, data storage local to the content server 120, data storage local to the playback device 130 or 131, and the like. As described in more detail below, the content listing generator 124 and the content provider 126 operate in concert with the content playback manager 132 to control the playback of selected content on the playback device 130 and/or 131 from content sources 110.

It will be apparent to those of ordinary skill in the art that an equivalent configuration could include multiple content server sites, each managing a portion of the functionality provided as described herein. A particular embodiment may include an additional layer, called the Partner Sites, wherein each Partner Site can be hosted on a separate server and each Partner Site can communicate with the client system 120 and/or the content playback manager 132 of a network-enabled playback device 130, described in more detail below. In this embodiment, each Partner Site can aggregate a subset of the available content from content sources 110. Further, it will be apparent to those of ordinary skill in the art that another equivalent. configuration could include a portion of the functionality provided by the client system 120 being downloaded from the content server 160 to client system 120 and executed locally at the client/user location. Further, it will be apparent to those of ordinary skill in the art that another equivalent configuration could include a portion of the functionality provided by the content playback manager 132 being downloaded from the content server 160 to playback devices 130 and/or 131 and executed locally at the playback/user location. In any of these alternative configurations, the content server-based content manager 161, client system content manager 121, and content playback manager 132 functionality provides and supports a system for enabling content aggregation by user proximity as described in more detail below.

### Description of Content Aggregation by User Proximity of an Example Embodiment

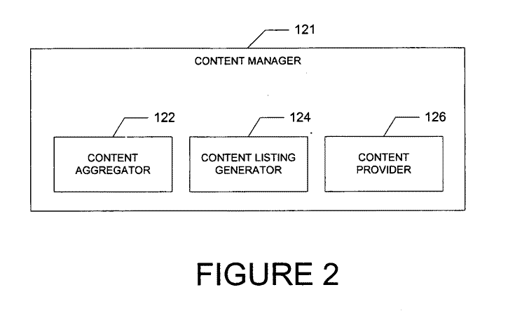

Referring now to FIG. 2, an example embodiment showing the functional components of the client system 120 content manager 121 is shown. As illustrated in FIG. 1 and described above, a client system 120 can be in data communication with one or more playback devices 130 and/or 131 via a local interface (e.g., USB, Bluetooth, 802.11, or 802.3) and/or a conventional network 105, such as a LAN or the Internet. As such, the client system 120 can receive access and content requests from a plurality of users of playback devices 130 and/or 131. The playback devices 130 and/or 131 can provide a content playback manager 132 to support the receipt of downloaded or streamed content from the client system 120, content server 160, or content sources 110. The functionality provided by the content manager 121 of a particular embodiment to support users can be partitioned into a set of functional components 122, 124, and 126. It will be understood that, in a particular embodiment, these functional components can be implemented in software executing on the client system 120. As described above, other equivalent configurations can also be implemented.

As shown in FIG. 2 for a first functional component of content manager 121, a content aggregator 122 is provided as part of content manager 121. Content aggregator 122 includes processing logic to communicate with the content server 160 and/or one or more content sources 110 to coordinate access to a user-selected item of content directly from the one or more content sources 110 for downloading or streaming the selected item of content to the user playback device 130 via network 105 or via the content server 160 and/or client system 120.

In a second functional component of content manager 121, a content listing generator 124 is provided as part of content manager 121. Content listing generator 124 includes processing logic to communicate with the content server 160 and/or with one or more content sources 110 to obtain available content listing information identifying particular items of content 112 available through particular content sources 110. In a particular embodiment, this content listing information can also include location information that can be used by the client system 120 to determine a physical distance between a physical location of the source of the particular content item and the physical location of a user or a playback device of a requesting user. Alternatively, the physical location of a content source can be determined from pre-configured data or determined by querying a particular content source or a related server for the current physical location of the content source. The content listing information from various content sources 110 can be posted on content server 160 and/or client system 120 for viewing, searching, and selection by users of client system 120 and/or playback devices 130 and/or 131. The users of playback devices 130 and/or 131 can log in to accounts maintained on content server 160 or client system 120, search a listing of available content, and select a particular item of content for download or streaming to the user's playback device via local interfaces or network 105.

In a third functional component of content manager 121, a content provider 126 is provided as part of content manager 121. The content provider 126 includes processing logic to communicate with the content server 160 and/or one or more content sources 110 and one or more playback devices 130 or 131 to facilitate the downloading or streaming of a particular selected item of content to a playback device of a requesting user.

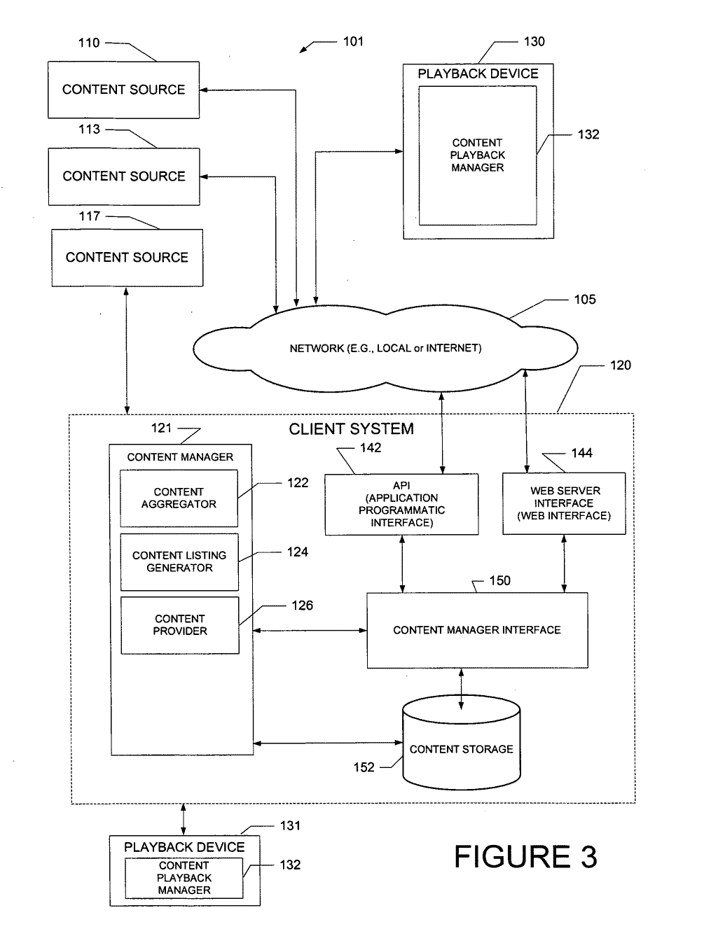

FIG. 3 illustrates another example embodiment of a networked system in which various embodiments may operate. As shown for an example embodiment, content manager 121 can be a component of a client system 120. Content manager 121 can use a content manager interface 150 to send and receive data to and/or from client system 120 via network 105. In a particular embodiment, content manager interface 150 can send and receive data to and/or from client system 120 via a web server interface 144 or an application programmatic interface (API) 142. Content manager interface 150 can also be used to receive content from content server 160 and/or content sources 110, 113, and/or 117 via a web server interface 144 or an application programmatic interface 142. As described above, the content aggregator 122 of the client system 120 includes processing logic to communicate with content server 160 and/or one or more content sources 110, 113, and/or 117 and, in concert with content playback manager 132, to coordinate the downloading or streaming of a user-selected item of content directly from the content sources 110, 113, and/or 117 to the client system 120 and/or the user playback device 130 via network 105. This content download or stream from a content source 110, 113, and/or 117 can be received by the content manager interface 150 and stored in the content storage 152 under control of the content aggregator 122 and the content provider 126. In this manner, and in a variety of alternative embodiments, content located at content sources 110, 113, or 117, content server 160, or in content storage 152 of client system 120 can be identified, accessed, and downloaded or streamed to a playback device 130 and/or 131 for playback by a user.

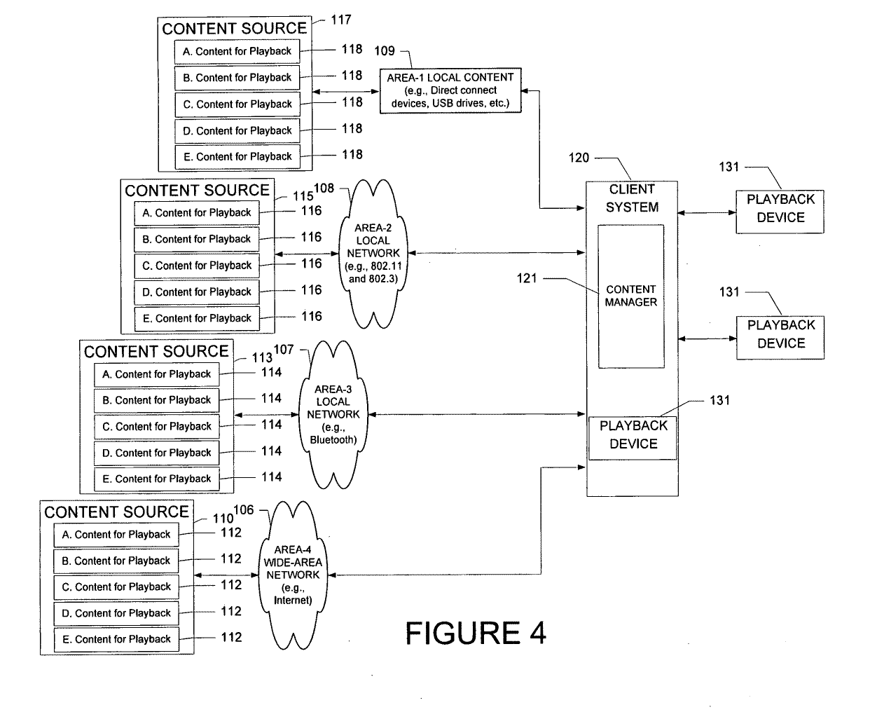

Referring now to FIG. 4, a networked system providing content for various playback devices from a variety of sources is illustrated. FIG. 4 illustrates another example embodiment of a networked system showing various content sources at four different levels of physical proximity where a client system manages the content. As described above and shown in FIG. 4, content for playback can be sourced by a variety of devices at a variety of locations. In some cases, the same item of content can be available to a user on a plurality of content sources. However, a user is often more likely to care about content that is physically closer to the user than content located at a source that is farther away. For instance, the user may wish to browse content that is within the user's physical proximity first, and/or the user most often browses the nearest content items. As such, it would be beneficial for a user to be able to view and select from content items that are arranged in a relationship corresponding to the physical proximity of the content item to the user. For example, as shown in FIG. 4, one content source 117 may correspond to local storage (local content) 109 on a user's local playback device or a USB drive that is coupled with the user's local playback device. The local content source 117 can provide storage for a set of content items 118 that the content manager 121 can identify and provide for the user for viewing and selection. Content source 117 can represent a set of content items 118 that are the most physically proximate to the user. These most local content items can be designated as AREA-1 content items. AREA-1 local content 109 can represent content sources that are storage media internal or embedded in a playback device 131 or in client system 120. AREA-1 local content 109 can also represent content sources that are USB storage devices or direct connect devices that directly interface to playback device 131 or client system 120.

Referring still to FIG. 4, another content source 115 may correspond to a set of content sources that are slightly more physically distant from a particular user's playback device than AREA-1 content sources. For example, locally networked content sources (for storing local network content) 115 can be accessible to a user's local playback device. The local network content source 115 can include wireless 802.11 or 802.3 devices, for example. These wireless devices can communicate over a relatively short range and thus can be considered local devices that can only operate a determinable physical distance from the user's local playback device. If one or more of these local network content sources 115 are within range of the client system 120 or a user's local playback device 131, the local network content sources 115 can provide storage for a set of content items 116 that the content manager 121 can identify and provide for the user for viewing and selection. Content source 115 can represent a set of content items 116 that are the next most physically proximate to the user. These next most local content items can be designated as AREA-2 content items. AREA-2 local network content source 115 can represent wireless 802.11 or 802.3 devices, Digital Living Network Alliance (DLNA) servers, FTP servers, Samba servers, and the like. These AREA-2 content sources 115 can interface to playback device 131 or client system 120 via the AREA-2 local network 108.

Referring still to FIG. 4, another content source 113 may correspond to a set of content sources that are slightly more physically distant from a particular user's playback device than AREA-2 and AREA-1 content sources. For example, locally networked content sources (for storing local network content) 113 can be accessible to a user's local playback device. The local network content source 113 can include wireless Bluetooth devices. These wireless devices can communicate over a relatively short range, yet typically have a wider (e.g., more distant) range than AREA-2 devices. Thus, wireless Bluetooth devices, and the like, can still be considered local devices that can only operate a determinable physical distance from the user's local playback device. If one or more of these local network content sources 113 are within range of the client system 120 or a user's local playback device 131, the local network content sources 113 can provide storage for a set of content items 114 that the content manager 121 can identify and provide for the user for viewing and selection. Content source 113 can represent a set of content items 114 that are the next most physically proximate to the user, yet more physically distant than AREA-1 or AREA-2 content source devices. These next most local content items can be designated as AREA-3 content items. AREA-3 local network content 114 can represent content stored on wireless Bluetooth devices, and/or on devices coupled to enhanced networks such as WiMAX and MIMO type networks, and the like. These AREA-3 content sources 113 can interface to playback device 131 or client system 120 via the local AREA-3 network 107.

Referring still to FIG. 4, another content source 110 may correspond to a set of content sources that are the most physically distant from a particular user's playback device than AREA-3, AREA-2, and AREA-1 content sources. For example, globally networked content sources. (for storing wide-area network content) 110 can also be accessible to a user's local playback device via a wide-area network such as the Internet. The wide-area network content source 110 can include any content server, content source, website, or remotely accessible content repository that is accessible via a wide-area network 106. If one or more of these wide-area network content sources 110 are accessible to the client system 120 or a user's local playback device 131, the wide-area network content sources 110 can provide storage for a set of content items 112 that the content manager 121 can identify and provide for the user for viewing and selection. Content source 110 can represent a set of content items 112 that are the most physically distant to the user, than AREA-1, AREA-2, or AREA-3 content source devices. These most physically distant content items can be designated as AREA-4 content items. AREA-4 wide-area network content 112 can represent any content provided by a content server, content source, website, or remotely accessible content repository that is accessible via a wide-area network 106. These AREA-4 content sources 110 can interface to playback device 131 or client system 120 via the AREA-4 wide-area network 106.

Thus, as illustrated in FIG. 4, collections of content can be arranged in a relationship corresponding to the physical proximity of the content item to the user. For example, four levels of physical proximity of content (e.g., AREA-1, AREA-2, AREA-3, and AREA-4) have been defined and shown in FIG. 4 based on the manner with which a particular content source can interface with a particular user playback device. It will be apparent to those of ordinary skill in the art that a greater or lesser number of physical proximity levels can be provided in a particular embodiment.

Given a definition of a plurality of physical proximity levels as described above, the content manager 121 of client system 120 can access each of the content sources at each physical proximity level to scan the content sources at that level for content items available for playback by a user. As the identity of content items at each physical proximity level are gathered, a list of the available content items can be generated and sorted and/or partitioned into content item groups based on the physical proximity of the content items to the user. In one embodiment, the most physically proximate content items (e.g., AREA-1 content items) can be displayed first in a content list (or content list portion) generated by the content manager 121. The next most physically proximate content items (e.g., AREA-2 content items) can be displayed next in the content list (or in a different portion of the content list) generated by the content manager 121, and so on. Similarly, if a user has entered search terms for searching for particular content items, the content manager 121 can arrange the search results in a sorted or grouped order determined by the physical proximity of the matching content items to the user submitting the search query. Additionally, a user can request playback of a particular content item and the content manager 121 can implicitly search for the specified content item starting with the most proximate area of content sources (e.g., AREA-1). If the requested content item is not found in AREA-1, the content manager 121 can implicitly search for the specified content item in the next most proximate area of content sources (e.g., AREA-2), and so on. In this manner, when a particular content item is requested for playback by a user, the user can be assured that the most physically proximate content item will be returned by the content manager 121.

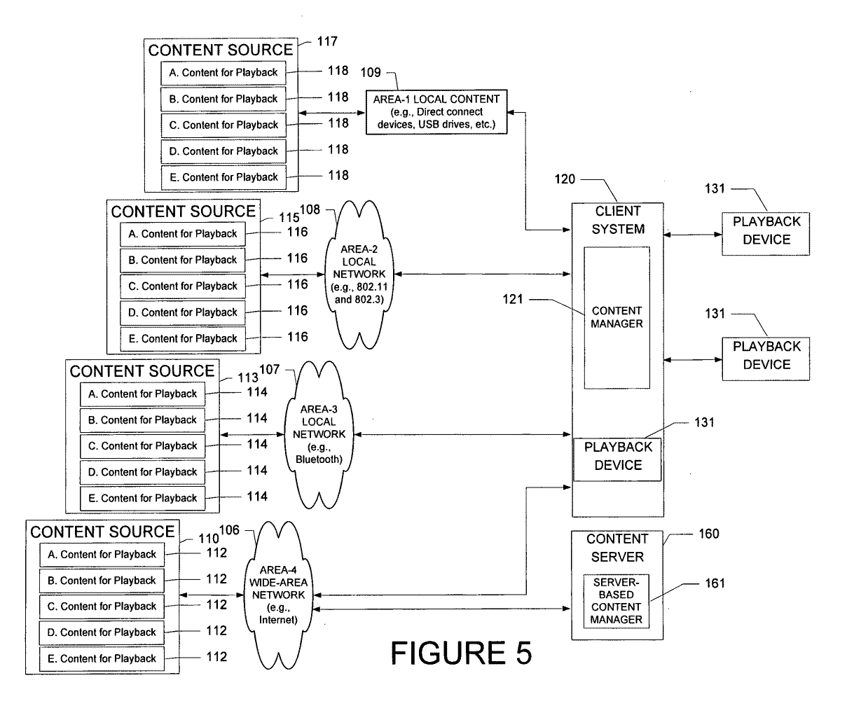

FIG. 5 illustrates an alternative embodiment of a networked system providing content for various playback devices from a variety of sources. FIG. 5 illustrates another example embodiment of a networked system showing various content sources at four different levels of physical proximity where a content server manages the content. As described above and shown in FIG. 4, content for playback can be sourced by a variety of devices at a variety of locations and collections of content can be arranged in a relationship corresponding to the physical proximity of the content item to the user. For example, four levels of physical proximity of content (e.g., AREA-1, AREA-2, AREA-3, and AREA-4) have been defined and shown in FIG. 4 based on the manner with which a particular content source can interface with a particular user playback device. In the embodiment of FIG. 4, the content manager 121 of client system 120 can access each of the content sources at each physical proximity level to scan the content sources at that level for content items available for playback by a user. In the embodiment of FIG. 5, the server-based content manager 161 of content server 160 can access each of the content sources at each physical proximity level to scan the content sources at that level for content items available for playback by a user. Content server 160 can access AREA-4 content sources via wide-area network 106. Content server 160 can also access client system 120 via wide-area network 106. In this manner, content server 160 can access AREA-3 local network 107, AREA-2 local network 108, and AREA-1 local content 109 via client system 120. As such, content server 160 and server-based content manager 161 can gain access to content sources 113, 115, and 117. Content server 160 and server-based content manager 161 can thereby gain access to the content items 114, 116, and 118 on these local content sources. Once content server 160 can access the content items 114, 116, and 118, server-based content manager 161 can scan the content sources at each physical proximity level for content items available for playback by a user. As the identity of content items at each physical proximity level are gathered, server-based content manager 161 can generate a list of the available content items and sort and/or partition the list into content item groups based on the physical proximity of the content items to the user. As described above for content manager 121, server-based content manager 161 can list, search, and/or play content items based on the physical proximity level from which the content item was sourced.

In another embodiment, the content manager 121 can periodically gather a list of local content accessible to client system 120 via AREA-1 interfaces and/or via local networks 107 and 108. This list of local content can be uploaded to content server 160 via wide-area network and retained in a local data storage repository of content server 160. Then, when a user of a playback device 131 or client system 120 requests a list of available content items, a search for a particular content item, or a playback of a particular content item, server-based content manager 161 can access the list of local content retained in the local data storage repository of content server 160 and generate a list of the available content items sorted and/or partitioned into content item groups based on the physical proximity of the content items to the user. The desired content item can be searched or played based on the physical proximity of the content items to the user.

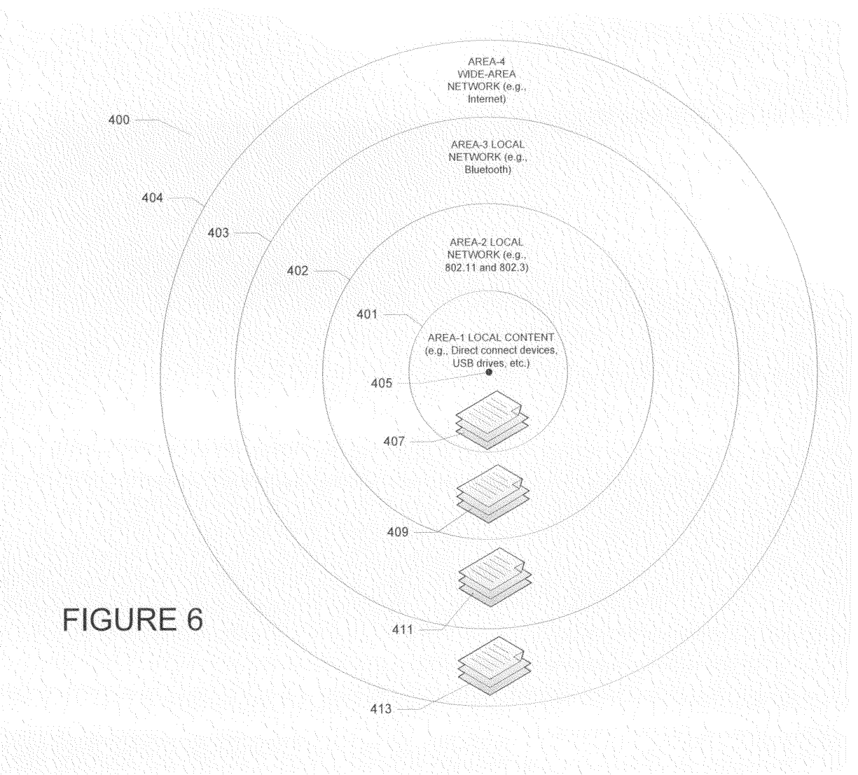

Referring now to FIG. 6, an example user interface 400 is illustrated. As described above, client system 120 and/or content server 160 can actively gather a list of content (both local and remote) that is accessible to client system 120. As further described above, this content list can be partitioned into a plurality of areas that relate to the physical proximity of particular content items to a user. FIG. 6 is an example user interface 400 in a particular embodiment that enables this content list to be conveniently presented to a computer user on a display screen of a client system 120 or a playback device 130 and/or 131. In the example user interface 400, a set of concentric rings (401-404) is shown, each ring corresponding to content items of the content list sourced from a particular physical proximity level as related to the physical position of the user. In the user interface 400, the location of the user is represented at a center 405 of the set of concentric rings (401-404). AREA-1 local content is represented as icons or display objects 407 within the ring 401. AREA-1 local content represents content items that are the most physically proximate to the user. As described above, AREA-1 local content represented by display objects 407 can represent content sources that are storage media internal or embedded in a playback device 131 or in client system 120. AREA-1 local content can also represent content sources that are USB storage devices or direct connect devices that directly interface to playback device 131 or client system 120. It will be apparent to those of ordinary skill in the art that display objects 407 can represent AREA-1 local content items in a variety of ways, including icons, links, menu items, widgets, and the like. Each of the content items represented by display objects 407 is located at a similar level of physical proximity to the user.

In a similar fashion, AREA-2 local network content is represented as icons or display objects 409 within the ring 402, but external to the ring 401. AREA-2 local network content represents content items that are the next most physically proximate to the user. As described above, AREA-2 local network content sources can represent wireless 802.11 or 802.3 devices, Digital Living Network Alliance (DLNA) servers, FTP servers, Samba servers, and the like. These AREA-2 content sources can interface to playback device 131 or client system 120 via the AREA-2 local network 108. It will be apparent to those of ordinary skill in the art that display objects 409 can represent AREA-2 local network content items in a variety of ways, including icons, links, menu items, widgets, and the like. Each of the content items represented by display objects 409 is located at a similar level of physical proximity to the user.

In a similar fashion, AREA-3 local network content is represented as icons or display objects 411 within the ring 403, but external to the ring 401 and the ring 402. AREA-3 local network content represents content items that are the next most physically proximate to the user. As described above, AREA-3 local network content can represent content stored on wireless Bluetooth devices, WiMAX, MIMO coupled devices, and the like. These AREA-3 content sources can interface to playback device 131 or client system 120 via the AREA-3 local network 107. It will be apparent to those of ordinary skill in the art that display objects 411 can represent AREA-3 local network content items in a variety of ways, including icons, links, menu items, widgets, and the like. Each of the content items represented by display objects 411 is located at a similar level of physical proximity to the user.

In a similar fashion, AREA-4 wide-area network content is represented as icons or display objects 413 within the ring 404, but external to the rings 401-403. AREA-4 wide-area network content represents content items that are the most physically distant to the user. As described above, AREA-4 wide-area network content can represent any content provided by a content server, content source, website, or remotely accessible content repository that is accessible via a wide-area network 106. These AREA-4 content sources 110 can interface to playback device 131 or client system 120 via the AREA-4 wide-area network 106. It will be apparent to those of ordinary skill in the art that display objects 413 can represent AREA-4 wide-area network content items in a variety of ways, including icons, links, menu items, widgets, and the like. Each of the content items represented by display objects 413 is located at a similar level of physical proximity to the user. It will also be apparent to those of ordinary skill in the art that the concentric rings 401-404 and the display objects 407, 409, 411, and 413, respectively therein can be represented in a variety of alternate ways, including portions of the interface 400 defined by ovals, rectangles, polygons, amorphous shapes, or the like. Moreover, a selected number of physical proximity levels, which in this case are illustrated by the concentric rings 401-404, are advantageously represented by partitions and/or portions of the user interface 400 having a number greater or lesser than four. In each case, a partitioning of a playable content list into physical proximity levels that are discernible to a user via the user interface 400 is provided. In some embodiments, the organization of the rings 401-404 of the user interface 400 comprises an estimated representation of the proximity between the user and the presented content listings. Further, the estimation of proximity may be predetermined and/or stored prior to presentation of the user interface 400 to the user. The estimation of proximity may also be determined in real time or on-the-fly at the time of presentation of the user interface 400, or a combination of predetermination and on-the-fly of determinations may advantageously be used. For instance, an initial determination of proximity is determined and stored, while on-the-fly determinations occur as content items are updated, and become available, and/or unavailable.

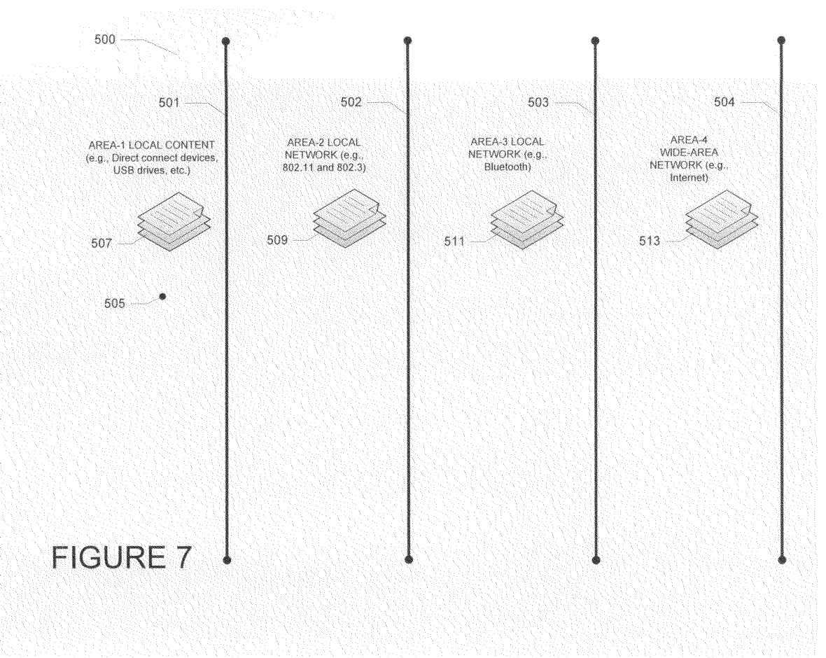

Referring now to FIG. 7, an example user interface 500 is illustrated. As described above, client system 120 and/or content server 160 can actively gather a list of content (both local and remote) that is accessible to client system 120. As further described above, this content list can be partitioned into a plurality of concentric areas or levels that relate to the physical proximity of particular content items to a user. FIG. 7 is another example user interface 500 in a particular embodiment that enables this content list to be conveniently presented to a computer user on a display screen of a client system 120 or a playback device 130 and/or 131. In the example user interface 500, a set of linear partition boundaries (501-504) is shown, each linear partition boundary corresponding to content items of the content list at a particular physical proximity level as related to the physical position of the user. In the user interface 500, the location of the user is represented at a point 505 on the leftmost side of user interface 500. Alternatively, the location of the user can also be represented at a point on the rightmost side, uppermost side, or lowermost side of user interface 500. AREA-1 local content is represented as icons or display objects 507 in a portion of the user interface 500 to the left of linear partition boundary 501. AREA-1 local content represents content items that are the most physically proximate to the user. As described above, AREA-1 local content represented by display objects 507 can represent content sources that are storage media internal or embedded in a playback device 131 or in client system 120. AREA-1 local content can also represent content sources that are USB storage devices or direct connect devices that directly interface to playback device 131 or client system 120. It will be apparent to those of ordinary skill in the art that display objects 507 can represent AREA-1 local content items in a variety of ways, including icons, links, menu items, widgets, and the like. Each of the content items represented by display objects 507 is located at a similar level of physical proximity to the user.

In a similar fashion, AREA-2 local network content is represented as icons or display objects 509 located in a portion of the user interface 500 to the left of linear partition boundary 502, but to the right of linear partition boundary 501. AREA-2 local network content represents content items that are the next most physically proximate to the user. As described above, AREA-2 local network content sources can represent wireless 802.11 or 802.3 devices, Digital Living Network Alliance (DLNA) servers, FTP servers, Samba servers, and the like. These AREA-2 content sources can interface to playback device 131 or client system 120 via the AREA-2 local network 108. It will be apparent to those of ordinary skill in the art that display objects 509 can represent AREA-2 local network content items in a variety of ways, including icons, links, menu items, widgets, and the like. Each of the content items represented by display objects 509 is located at a similar level of physical proximity to the user.

In a similar fashion, AREA-3 local network content is represented as icons or display objects 511 located in a portion of the user interface 500 to the left of linear partition boundary 503, but to the right of linear partition boundary 501 and 502. AREA-3 local network content represents content items that are the next most physically proximate to the user. As described above, AREA-3 local network content can represent content stored on wireless Bluetooth devices, and the like. These AREA-3 content sources can interface to playback device 131 or client system 120 via the local AREA-3 network 107. It will be apparent to those of ordinary skill in the art that display objects 511 can represent AREA-3 local network content items in a variety of ways, including icons, links, menu items, widgets, and the like. Each of the content items represented by display objects 511 is located at a similar level of physical proximity to the user.

In a similar fashion, AREA-4 wide-area network content is represented as icons or display objects 513 located in a portion of the user interface 500 to the left of linear partition boundary 504, but to the right of linear partition boundary 501-503. AREA-4 wide-area network content represents content items that are the most physically distant to the user. As described above, AREA-4 wide-area network content can represent any content provided by a content server, content source, website, or remotely accessible content repository that is accessible via a wide-area network 106. These AREA-4 content sources 110 can interface to playback device 131 or client system 120 via the wide-area AREA-4 network 106. It will be apparent to those of ordinary skill in the art that display objects 513 can represent AREA-4 wide-area network content items in a variety of ways, including icons, links, menu items, widgets, and the like. Each of the content items represented by display objects 513 is located at a similar level of physical proximity to the user. It will also be apparent to those of ordinary skill in the art that the linear partition boundaries 501-504 and the display objects 507, 509, 511, and 513, respectively therein can be represented in a variety of alternate ways, including arcs, graphical images, curved lines, amorphous linear shapes, or the like. It will also be apparent to those of ordinary skill in the art that a number of linear partition boundaries or physical proximity levels greater or lesser than four may be similarly used. In each case, a partitioning of a playable content list into physical proximity levels that are discernible to a user via the user interface 500 is provided.

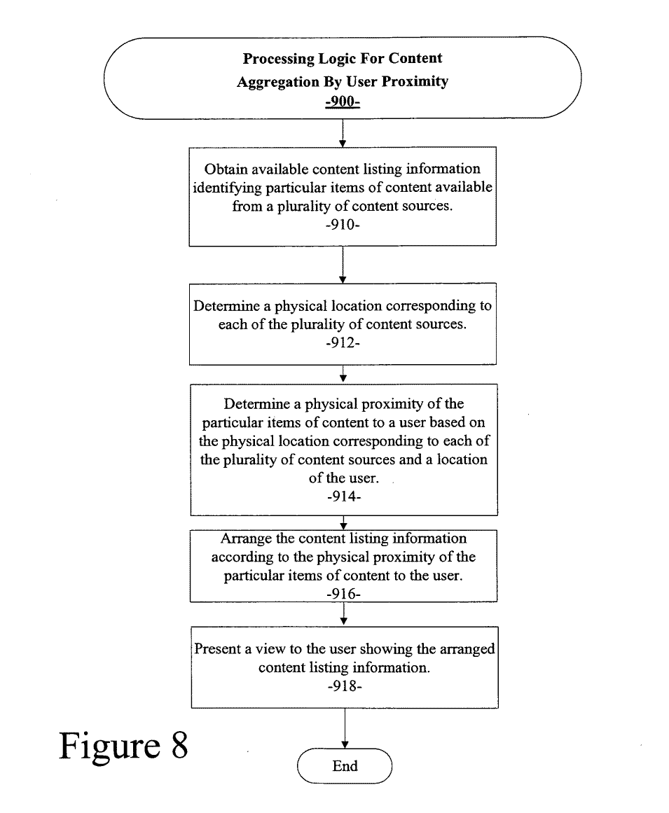

FIG. 8 is a processing flow diagram illustrating a sequence of processing operations in an example embodiment. As shown, processing operations performed by an example embodiment 900 include: obtaining available content listing information identifying particular items of content available from a plurality of content sources (processing block 910); determining a physical location corresponding to each of the plurality of content sources (processing block 912); determining a physical proximity of the particular items of content to a user based on the physical location corresponding to each of the plurality of content sources and a location of the user (processing block 914); arranging the content listing information according to the physical proximity of the particular items of content to the user (processing block 916); and presenting a view to the user showing the arranged content listing information (processing block 918).

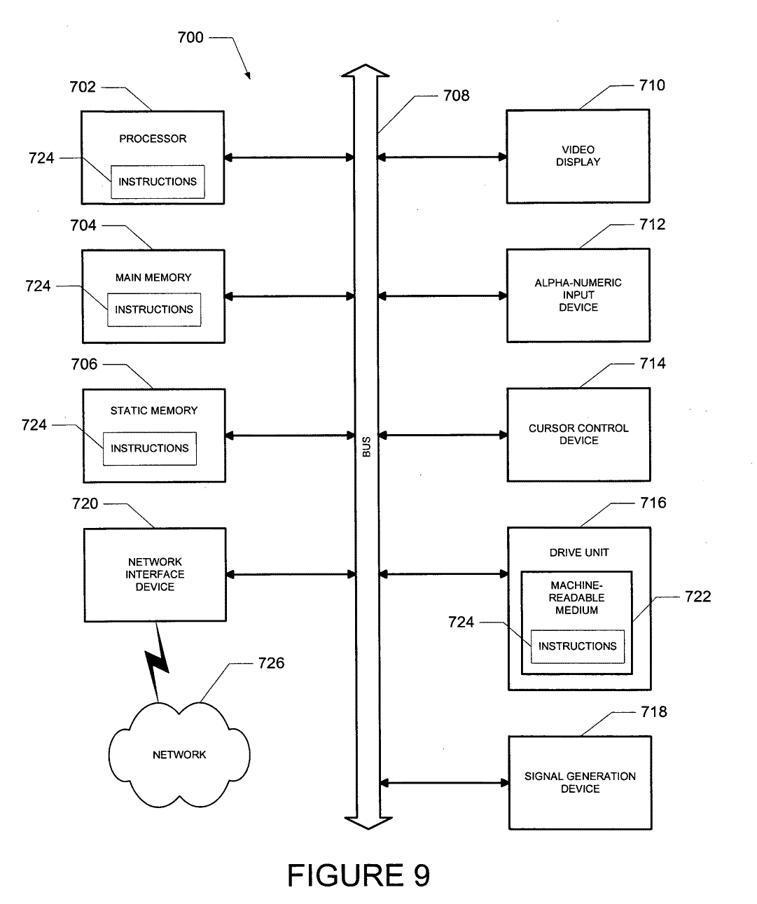

FIG. 9 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, an audio or video player, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical and magnetic media, and carrier wave signals. As noted, the software may be transmitted over a network using a transmission medium. The term “transmission medium” shall be taken to include any medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

The system of an example embodiment may include software, information processing hardware, and various processing steps, which are described herein. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and apparatus described herein is equally applicable to other network infrastructures or other data communications systems.

Various embodiments are described herein. In particular, the use of embodiments with various types and formats of user interface presentations and/or application programming interfaces may be described. It can be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

Thus, a computer-implemented system and method for enabling content aggregation by user proximity are disclosed. While the present invention has been described in terms of several example embodiments, those of ordinary skill in the art can recognize that the present invention is not limited to the embodiments described, but can be practiced with modification and alteration within the spirit and scope of the appended claims. The description herein is thus to be regarded as illustrative instead of limiting.

What is claimed is:

1. A computer-implemented method comprising:
obtaining available content listing information identifying particular items of content available from a plurality of content sources;
determining a physical location corresponding to each of the plurality of content sources;
determining a physical proximity of the particular items of content to a user based on the physical location corresponding to each of the plurality of content sources and a location of the user;
arranging the content listing information according to the physical proximity of the particular items of content to the user; and
presenting a view to the user showing the arranged content listing information.

2. The computer-implemented method of claim 1 wherein at least one of the plurality of content sources is a USB storage device.

3. The computer-implemented method of claim 1 wherein at least one of the plurality of content sources is a wireless 802.11 device.

4. The computer-implemented method of claim 1 wherein at least one of the plurality of content sources is a Bluetooth device.

5. The computer-implemented method of claim 1 further including partitioning the content listing information into physical proximity levels that are discernible to a user via a user interface.

6. The computer-implemented method of claim 1 wherein the view includes a plurality of concentric circles representing a partitioning of the content listing information into a corresponding plurality of physical proximity levels.

7. The computer-implemented method of claim 1 wherein the view includes a plurality of linear partition boundaries representing a partitioning of the content listing information into a corresponding plurality of physical proximity levels.

8. An apparatus comprising:
a content manager having a data network interface, the content manager being configured to:
obtain available content listing information identifying particular items of content available from a plurality of content sources;
determine a physical location corresponding to each of the plurality of content sources;
determine a physical proximity of the particular items of content to a user based on the physical location corresponding to each of the plurality of content sources and a location of the user;
arrange the content listing information according to the physical proximity of the particular items of content to the user; and
present a view to the user showing the arranged content listing information.

9. The apparatus of claim 8 wherein at least one of the plurality of content sources is a USB storage device.

10. The apparatus of claim 8 wherein at least one of the plurality of content sources is a wireless 802.11 device.

11. The apparatus of claim 8 wherein at least one of the plurality of content sources is a Bluetooth device.

12. The apparatus of claim 8 being further configured to partition the content listing information into physical proximity levels that are discernible to a user via a user interface.

13. The apparatus of claim 8 wherein the view includes a plurality of concentric circles representing a partitioning of the content listing information into a corresponding plurality of physical proximity levels.

14. The apparatus of claim 8 wherein the view includes a plurality of linear partition boundaries representing a partitioning of the content listing information into a corresponding plurality of physical proximity levels.

15. An article of manufacture comprising a machine-readable storage medium having machine executable instructions embedded thereon, which when executed by a machine, cause the machine to:
obtain available content listing information identifying particular items of content available from a plurality of content sources;
determine a physical location corresponding to each of the plurality of content sources;
determine a physical proximity of the particular items of content to a user based on the physical location corresponding to each of the plurality of content sources and a location of the user;
arrange the content listing information according to the physical proximity of the particular items of content to the user; and
present a view to the user showing the arranged content listing information.

16. The article of manufacture of claim 15 wherein at least one of the plurality of content sources is a USB storage device.

17. The article of manufacture of claim 15 wherein at least one of the plurality of content sources is a wireless 802.11 device.

18. The article of manufacture of claim 15 wherein at least one of the plurality of content sources is a Bluetooth device.

19. The article of manufacture of claim 15 being further configured to partition the content listing information into physical proximity levels that are discernible to a user via a user interface.

20. The article of manufacture of claim 15 wherein the view includes a plurality of concentric circles representing a partitioning of the content listing information into a corresponding plurality of physical proximity levels.

21. A user interface for presentation of content from a plurality of sources, the user interface being executable by a processor with a data network interface, the user interface comprising:
a list of available content, the list for listing information identifying particular items of content available from a plurality of content sources;
an indicator of a physical proximity of the particular items of content to a user based on a physical location corresponding to each of the plurality of content sources and a location of the user; and
an arrangement of the content listing information according to the physical proximity of the particular items of content to the user,
wherein the user interface presents a view to the user showing the arranged content listing information, the view comprising a plurality of concentric rings corresponding to an estimated proximity to the user of the presented content items.

22. The user interface of claim 21, wherein the estimated proximity for each content item comprises at least one of:
a predetermination of the proximity to the user, the predetermination stored for presentation to the user; and
an on-the-fly determination of the proximity to the user, the on-the-fly determination performed at the time of presentation to the user.

23. The user interface of claim 21, wherein the plurality of content sources comprises at least one of a local storage device, and a wireless device.
